(19) United States
(12) Patent Application Publication
(10) Pub. No.: US 2018/0244164 A1
(43) Pub. Date: Aug. 30, 2018

(54) BATTERY CHARGING STATIONS AND ASSOCIATED METHODS OF USE

(71) Applicant: FAA, LLC, Merritt Island, FL (US)

(72) Inventor: Dennis Foldesi, Merritt Island, FL (US)

(21) Appl. No.: 15/905,928

(22) Filed: Feb. 27, 2018

Related U.S. Application Data
(63) Continuation of application No. 15/149,907, filed on May 9, 2016, now abandoned.
(60) Provisional application No. 62/159,008, filed on May 8, 2015.
(60) Provisional application No. 62/287,957, filed on Jan. 28, 2016.

(51) Int. Cl. B60L 11/18; H02J 7/00

(52) U.S. Cl. CPC B60L 11/1811; H02J 7/0027; B60L 11/1838; Y02T 10/7055; H02J 7/0004; H02J 2007/0001; B60L 11/1803

(57) ABSTRACT

The present technology relates generally to battery charging systems and, more particularly, to charging stations for electric vehicles that can be transported to the vehicle's location on demand.

### PRIORITY DATA

This U.S. patent application is a continuation of U.S. patent application Ser. No. 15/149,907 filed May 9, 2016, which claims the priority benefit of U.S. Provisional Patent Application Ser. No. 62/159,008, filed May 8, 2015 and U.S. Provisional Patent Application Ser. No. 62/287,957 filed Jan. 28, 2016, the entire contents of each of which are incorporated herein by reference and relied upon.

### TECHNICAL FIELD

The present technology relates generally to battery charging systems and, more particularly, to charging stations for electric vehicles that can be transported to the vehicle's location on demand.

### BACKGROUND

Various types of charging systems are known for charging a rechargeable battery (e.g., of an electric and/or hybrid vehicle). A rechargeable battery can be used in, for example, a vehicle to provide power for propulsion or other electrical systems of the vehicle. Typically, the charging systems are connected to an external source of power (e.g., an electric utility grid) via one or more cables. The external source of power can provide electric power in the form of alternating current (AC) power to recharge the battery. However, the vehicle may not always be in a location with access to a convenient external source of power.

### BRIEF DESCRIPTION OF THE DRAWINGS

FIG. 1 is a schematic diagram of an electric vehicle having a battery charging system configured in accordance with an embodiment of the present technology.

FIG. 2 is a schematic diagram of a provider vehicle for transporting charging stations, in accordance with an embodiment of the present technology.

FIG. 3 illustrates a system for enabling transport of charging stations, according to some embodiments.

FIG. 4 illustrates a mobile communication device that can be used by either customers or providers, according to some embodiments.

FIG. 5 illustrates a process for programmatically transferring funds from a customer to a relevant provider as a mechanism for compensating the provider for transport and recharging services, according to an embodiment.

### DETAILED DESCRIPTION

The present technology describes various embodiments of charging stations that can be transported to the location of an electric vehicle. In one embodiment, for example, a battery charging system of the vehicle is configured to be connected or is connected to a charging station. The battery charging system of the vehicle can use the power provided by the charging station to recharge the vehicle's battery (e.g., through one or more cables or other connectors).

The charging station is dispatched to the location of the electric vehicle after a request is made by a customer to a recharging system. The request may include a location of the customer's vehicle. The recharging system may then invite one or more charging station providers to transport a charging station to the customer's vehicle location and recharge the vehicle.

In some embodiment's, multiple charging stations may be transported by a provider. The provider may connect a charging station to a first customer's vehicle. Then while the first customer's vehicle recharges, the provider may transport other charging stations to other customers' vehicles. In some embodiments, the provider's vehicle includes a charging system for recharging one or more charging stations. The charging stations may store power in one or more batteries. In other embodiments, the charging stations may include an internal combustion generator for providing power to recharge a customer's vehicle or to charge the batteries of the charging stations.

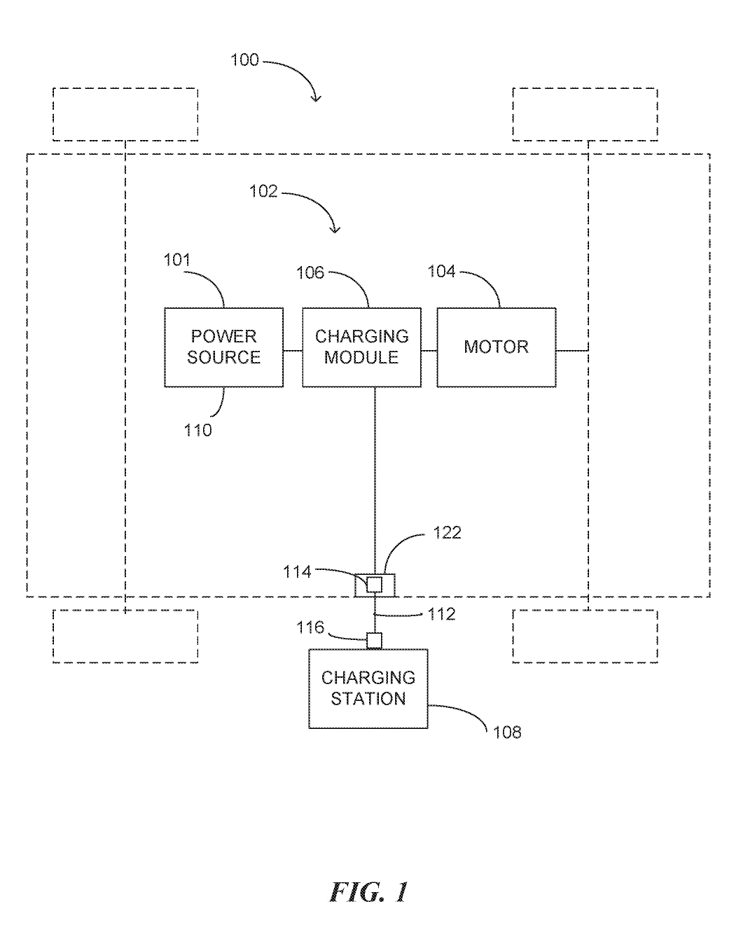

Certain details are set forth in the following description and in FIGS. 1-5 to provide a thorough understanding of various embodiments of the present technology. Other details describing well-known structures and systems often associated with battery charging systems and electric vehicles including connectors, chargers, power supplies, electric vehicle management systems, charging circuits, rectifiers, transistors, cables, switches, inverters, converters, batteries, sensors, controllers, circuits, user interfaces and propulsion, electrical, or heating and cooling systems, etc. have not been set forth in the following disclosure to avoid unnecessarily obscuring the description of the various embodiments of the present technology.

Many of the details, dimensions, angles and other features shown in the Figures are merely illustrative of particular embodiments of the present technology. Accordingly, other embodiments can add other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 illustrates a schematic diagram of a vehicle 100 and other various components of the vehicle 100 that a battery charging system 102 can be integrated with, positioned within and/or connected to according to various embodiments of the present technology. In various embodiments, the vehicle 100 can be an electric vehicle. Electric vehicles include vehicles that typically include one or more power sources 101 (e.g., batteries 110) configured to store and provide power to propel the vehicle and/or power other onboard electrical devices or systems. Electrical vehicles can include automobiles, trucks, boats, jet skis, utility or all-terrain vehicles, forklifts, etc. In other embodiments, the vehicle 100 can include a hybrid vehicle.

In the illustrated embodiment, the vehicle 100 is an electric vehicle (e.g., manufactured by Tesla, Chevrolet, Nissan, Toyota, Honda, BMW, Fiat, Hyundai, Ford or other manufacturers) and includes a power source 101 (e.g., one or more batteries 110) and at least one motor 104. The motor 104 converts power supplied by the power source 101 into mechanical motion (e.g., motion to move or propel the vehicle 100). The power source 101 can be connected to the battery charging system 102.

In one embodiment, the battery charging system 102 is able to receive a supercharge and/or to provide a supercharge to a supercharge-capable vehicle 100, for example as described in U.S. Pat. No. 8,643,330, hereby incorporated by reference herein in its entirety. In one embodiment, the battery charging system 102 can deliver at least about 100 kW, at least about 110 kW, at least about 120 kW or at least about 130 kW of direct current power directly to the power source 101. In one embodiment, the battery charging system 102 is configured to gradually reduce current supplied to the power source 101 as the power source nears a full charge (e.g. at least 80%, at least 85% at least 90% or at least 95%).

In one embodiment, the battery charging system 102 is able to deliver a full charge of at least about 250, at least about 255, at least about 265, at least about 275, at least about 285, at least about 300, at least about 350 or at least about 400 miles of driving to an 85 kWh vehicle in 80 minutes or less, 75 minutes or less, 70 minutes or less, 65 minutes or less, 60 minutes or less, 55 minutes or less, 50 minutes or less, 45 minutes or less, 40 minutes or less, 35 minutes or less or 30 minutes or less.

In one embodiment, the battery charging system 102 comprises a system that allows for distributing charging power among a plurality of charge ports 122 (a, b, c, etc.) of the battery charging system 102, where the battery charging system 102 includes a plurality of power stages 130-132 where each power stage 130-132 includes an AC to DC converter and wherein each power stage 130-132 provides a portion of the charging system's maximum available charging power.

In one embodiment, the plurality of parallel power stages are grouped together into groups of three forming a power block. For example power stages 130-132 are grouped together into power block 140; power stages 133-135 are grouped together into power block 141 and power stages 136-139 are grouped together into power block 142. Grouping into blocks of three helps to insure that the three phase AC side remains balanced. If imbalance is allowed, then the power stages need not be grouped together, thus allowing power distribution into smaller discrete power steps.

The power source 101 stores power that can be delivered (e.g., supplied or provided) to the motor 104 (e.g., directly or indirectly through a charging module 106, inverter, and/or converter, etc.) for propelling the vehicle 100 and/or other electrical systems and devices (e.g., a vehicle management system, display system, HVAC system) of the vehicle 100. In the illustrated embodiment, the power source 101 includes one or more rechargeable batteries 110. The rechargeable battery 110 can include one or more battery cells that are electrically coupled to form the rechargeable battery 110. In some embodiments, the rechargeable battery 110 includes one or more lithium ion batteries coupled in parallel and/or series.

Referring to FIG. 1, in one aspect of this embodiment, the battery charging system 102 includes one or more charging modules 106 (e.g., power converters, charging stations, inverters, power supplies and/or rectifiers, etc.) positioned on-board and/or inside the vehicle 100 and connected to the power source 101. In other embodiments, the charging module 106 can be positioned or located outside of the vehicle 100. The charging module 106 is configured to receive power transmitted from an external power source (e.g., a portable power station 108) and charge the power source 101. In some embodiments, the charging module 106 can also be configured to convert DC power supplied by the power source 101 to AC power that is useable by the motor 104 to propel the vehicle. In other embodiments, a separate inverter, rectifier or converter can be used to convert the DC power supplied by the power source 101 into AC power for the motor 104. In some embodiments, the motor 104 can be configured to run on DC power. In some embodiments, the charging module 106 can monitor and control the charging of the power source 101 (e.g., voltage, charging rate, temperature of the power source 101).

The charging module 106 can be connected to the charging station 108 via one or more detachable connectors 112 (e.g., cables). For example, the connector 112 can include a first plug 114 on one end for connection to the vehicle 100 (e.g., via a charge port 122 that is electrically coupled to the charging module 106) and a second plug 116 on an opposite end of the connector 112 for connection to charging station 108, such that power can flow between the charging station 108 and the charging module 106. In some embodiments, the connector 112 is permanently connected to the charging station 108. The charging station 108 may include one or more batteries for storing power. In some embodiments, the charging station 108 may include an internal combustion generator for supplying power.

In one embodiment, the output from each of the power blocks 140-142 is coupled to a plurality of charger ports 122a, 122b, 122c, etc., via switching system 150. In one embodiment, switching system 150 includes a plurality of contactors, or semiconductor switches, or other switching means, that allow the output from each of the power blocks to be electrically connected to any of the charger ports 122. Preferably switching system 150, or a control system that operates switching system 150, does not allow one charging port, to be coupled to another charging port. Using switching system 150, the amount of power that is coupled to a particular vehicle, via a charger port, may be tailored depending upon vehicle needs, charger port use, vehicle charging priority, fees, etc. In one embodiment, a controller 160, coupled to switching system 150, determines the distribution of power from the power blocks to the charger ports by applying a predefined set of distribution rules recorded in memory 175. In at least one embodiment, controller 160 is a processor-based control system (e.g., microprocessor) and memory 175 is a flash memory, solid state disk drive, hard disk drive, or other memory type or combination of memory types. Also coupled to controller 160 is a system monitor 180 which continually monitors the charging system, including vehicle/port conditions. In particular, system monitor 180 continually monitors ports 122a, 122b, 122c, etc., in order to determine when a vehicle is coupled to the charging system. Preferably system monitor 180 also obtains vehicle information through the ports, although such information may also be provided via other means (e.g., wireless network, vehicle ID such as an RFID tag, etc.). Preferably the vehicle information obtained through these means will include vehicle battery capacity, current state-of-charge (SOC), desired SOC, charging capabilities of the battery, battery temperature, etc. In one embodiment, system monitor 180 also is coupled to the power stages, or power blocks, in order to obtain power output/capabilities of each stage and/or block, monitoring for changing output conditions or problems within a stage/block. In at least one embodiment, system monitor 180 also monitors the input line in order to detect line problems. System monitor 180 may also include, or be coupled to, subsystem 185 which determines charging fees. Charging fees may vary based on the time of day, the cost of the power provided by the power source 101, or based on other conditions. Preferably system monitor 180 also includes one or more subsystems 186 for accepting money from the end user and, in at least some cases, determining an amount of money input by the end user. For example, subsystem 186 may be capable of accepting cash from the end user and determining how much cash was input. Subsystem 186 may also be capable of accepting credit cards or debit cards or other forms of non-cash payment. Preferably system monitor 180 also includes a subsystem 187 for updating distribution instructions or other aspects of charging system 102. Subsystem 187 may include either a wireless or wired internet connection. Subsystem 187 may also utilize a different communication system/protocol for obtaining system updates.

In a charging system with three power blocks, and assuming that each power block is configured to output the same amount of power, the power can be distributed at four different levels; 0 output, ⅓ Pₘₐₓ, ⅔ Pₘₐₓ, and Pₘₐₓ, where Pₘₐₓ is equal to the maximum available power from charging system, i.e., with all three power blocks coupled to a single port. As a result of this design, and as noted above, controller 160 can distribute the available power to the vehicles coupled to the charger's ports in a variety of different ratios depending upon the criteria used by the control system to determine power distribution.

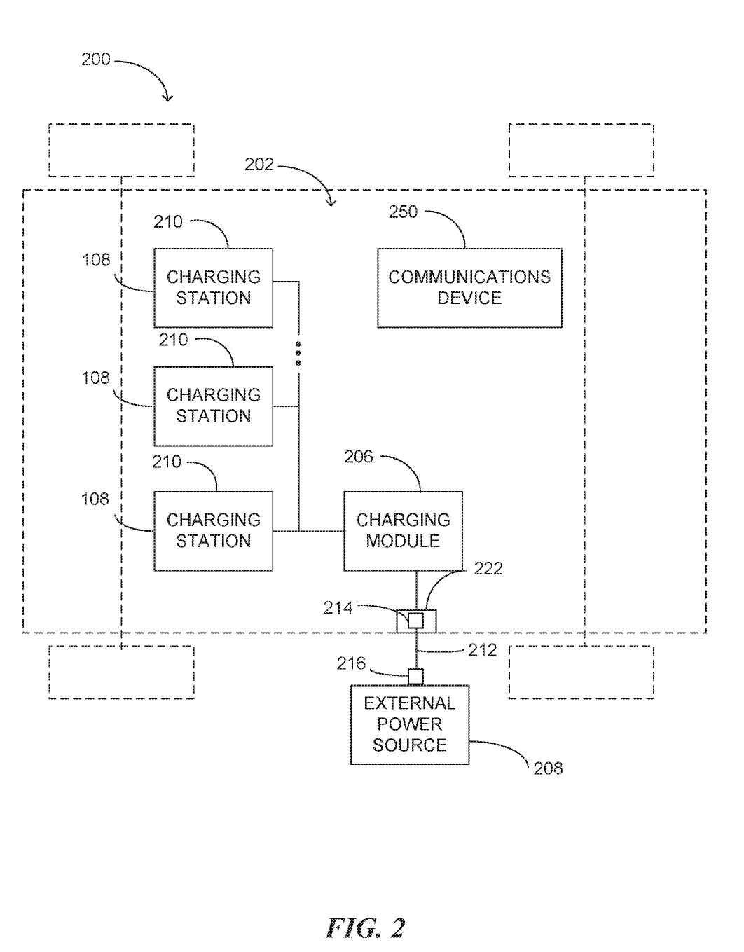

FIG. 2 illustrates a schematic diagram of a provider vehicle 200 and other various components of the provider vehicle 200 that a portable charging system 202 can be integrated with, positioned within and/or connected to according to various embodiments of the present technology. In various embodiments, the provider vehicle 200 transports and recharges one or more charging stations 108. The charging stations 108 store power that can be delivered (e.g., supplied or provided) to a vehicle 100 that has requested recharging. In the illustrated embodiment, the charging stations 108 include one or more rechargeable batteries 210. The rechargeable batteries 210 can include one or more battery cells that are electrically coupled to form the rechargeable batteries 210. In some embodiments, the rechargeable batteries 210 includes one or more lithium ion batteries coupled in parallel and/or series.

Referring to FIG. 2, in one aspect of this embodiment, the portable charging system 202 includes one or more charging modules 206 (e.g., power converters, charging stations, inverters, power supplies and/or rectifiers, etc.) positioned on-board and/or inside the provider vehicle 200 and connected to the charging stations 108. In other embodiments, the charging module 206 can be positioned or located outside of the provider vehicle 200. The charging module 206 converts power (e.g., 110V AC power, 220V AC power, 240V AC power) transmitted from an external power source 208 (e.g., power from a utility grid of a house via an outlet, circuit, and/or panel, etc. and/or power from a charging or supercharging station) into power (e.g., DC power) storable by the charging stations 108 (e.g., the batteries 210) to recharge the charging stations 108. In some embodiments, the charging module 206 can monitor and control the charging of the charging stations 108 (e.g., voltage, charging rate, temperature of the charging stations 108).

The charging module 206 can be connected to the external power source 208 via one or more detachable connectors 212 (e.g., cables). For example, the connector 212 can include a first plug 214 on one end for connection to the provider vehicle 200 (e.g., via a charge port 222 that is electrically coupled to the charging module 206) and a second plug 216 on an opposite end of the connector 212 for connection to external power source 208, e.g., via an electrical outlet (e.g., a 110V standard household outlet or a 240V NEMA 14-50 outlet) such that power can flow between the external power source 208 and the charging module 206. In some embodiments, the connector 112 connects the charging module 206 to the external power source 208 that is a charging or supercharging station (e.g., by Tesla or other manufacturers) away from a house.

The charging stations 108 are configured to be transported to a location of another vehicle 100 that requested recharging by the provider vehicle 200. Once at the location of the other vehicle 100, one of the charging stations may be disconnected and removed from the provider vehicle 200. The charging station 108 may then be connected to the other vehicle as illustrated in FIG. 1 to charge the power source 101 of the vehicle. While the charging station 108 provides power to the vehicle 100, the provider vehicle may transport the other charging stations 108 to other vehicles that have requested recharging. Alternatively, the provider vehicle may recharge the other charging stations 108 by connecting the charging module 206 to an external power source 208.

Information about the provider vehicle 200 and the vehicle 100 requesting recharging may be communicated via a communications device 250. The communication device 250 may be a device within the provider vehicle 200, such as a dashboard display, navigation system, portable computer, mobile telephone, or any other portable communications device. The communication device 250 receives a request for recharging from a customer and a location of the customer's vehicle 100. The communication device 250 may transmit a confirmation to the customer that the provider vehicle 200 will transport a charging station 108 to the location of the customer's vehicle 100. The communication device 250 may also transmit the location of the provider vehicle 200 and an estimated transport and recharging time for the charging station 108 to the customer. The communication device 250 may also provide billing and navigation assistance for the provider vehicle 200.

In an alternative embodiment, the charging stations 108 may be in fixed locations. In this embodiment, the provider may connect a customer's vehicle 100 to a charging station 108 after receiving a request from the customer, as described above. However, instead of transporting the charging station 108 to the customer's vehicle location, the provider may transport the customer's vehicle to the fixed location of the charging station 108.

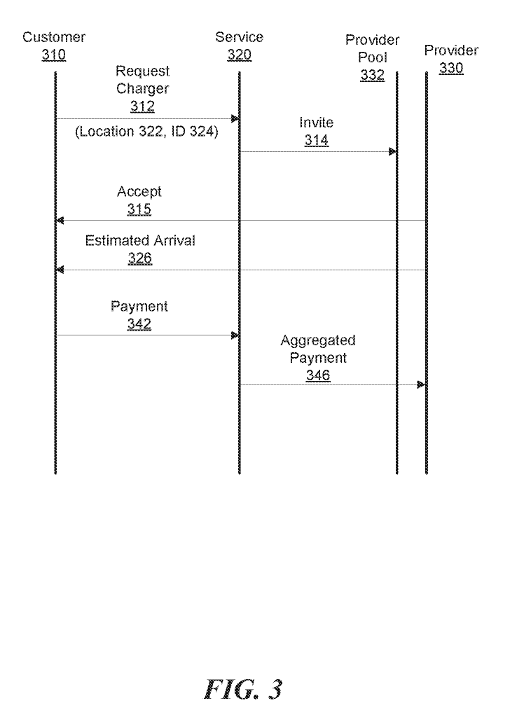

FIG. 3 illustrates a system for enabling transport of charging stations, according to some embodiments. In an embodiment, a customer 310 (also referred as to a customer) is able to make a request to recharge a vehicle using a computing device. A transport service 320 locates a provider 330 (also referred to as ‘respondent’ or ‘driver’) from a pool of possible providers 332, in order to drive a charging station to the location of the customer's vehicle.

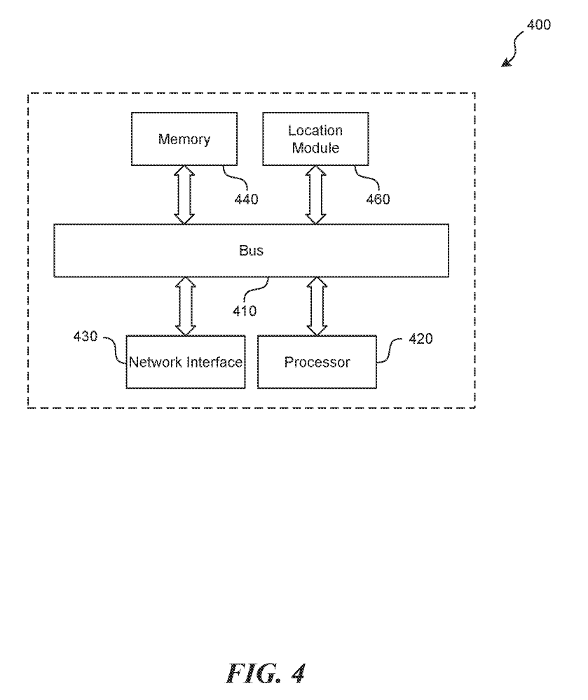

According to some embodiments, the customer 310 operates a handset to generate a request for a charger 312. As described in FIG. 4, the handset may include roaming network capabilities (e.g. network interface for cellular network, Wireless Fidelity 802.11(a), (g) (n), or WiMax etc.), along with geo-aware resources (e.g. GPS). The network functionality enables the handset to transmit request 312 and communicate further with service 320 or providers 330. The geo-aware resources enable the handset to automatically include geographic identification information 322 that identifies the geographic location of the customer 310 when making the request 312. The handset may also be configured to include identification information 324 that identifies the customer 310 and/or the customer's vehicle to either the service 320 or to the provider 330. The identification information 324 includes, for example, a name, account number, vehicle information, and/or picture of the customer or vehicle making the request 312. A vehicle location may also be included or provided with the identification information 324.

According to an embodiment, the service 320 processes the request 312 in order to select candidate providers that can provide the requested charging station. The service 320 is able to use identification information 324 to identify an account or profile of the customer. The account or profile of the customer may include or identify funds for payment for the recharging service. Other information that may optionally be associated or maintained with the user account/profile includes, for example, an image of the customer, an image of the customer's vehicle, and preferences of the customer. Such preferences and other profile information can be used to select providers for the customer at a given instance. For example, for a given request 312, the service 320 may first attempt to locate a provider 330 that the customer has previously used.

As an alternative or addition, some or all of the account/profile information may be stored with the customer, and communicated as part of the request 312.

Service 320 uses information contained in the customer request 312 to select candidate providers based on one or more criteria. The criteria may include (i) proximity of the individual candidate providers to the customer's vehicle location, and (ii) availability of the candidate providers. As mentioned, the criteria may also include user-specified preferences, including specific identification by the user of a particular provider, or previous providers that have serviced the user and whom have received good feedback from the user. In order to arrange transport to the customer's vehicle location, an embodiment provides that the service 320 implements a pairing process upon receipt of the request 312. The service 320 performs the pairing process by (i) using the one or more criteria to select a first candidate provider; (ii) sending an invitation 314 to the first candidate, and giving the first candidate a short duration to accept the invitation; (iii) if the first candidate respondent declines or fails to accept the invitation, selecting a second candidate respondent using the one or more criteria; (iv) sending the invitation 314 to the second candidate, and giving the second candidate a short duration to accept. The pairing process may be repeated (n times) until a provider 330 from the provider pool 332 communicates back an acceptance 315 to the invitation 314.

As an alternative to a single pairing process, another embodiment provides for selecting providers by contacting a set of two or more providers at once, based on criteria such as described above. The particular provider that ultimately is selected may correspond to, for example, the first provider in the set to respond and accept the invitation 314.

Either as part of the invitation 314, or in a follow on communication (following acceptance 315 of the invitation), the service 320 may specify, to the selected provider 330, information about the customer 310 that includes: (i) the expected cost of the transport and recharging for that customer (which may include determining and communicating the customer's vehicle battery level), and/or (ii) the geographic location of the customer's vehicle. The vehicle's picture or other identification information may also be communicated to the accepting provider. Thus, for example, the provider 330 is able to identify the customer's vehicle 310 from sight when he arrives to charge the customer's vehicle.

According to embodiments, the pool of providers 332 are equipped with devices that can communicate with geo-aware mobile devices (e.g. handsets) of the customers. In particular, the pool of respondents 332 may include portable/mobile and personal communication devices 250, such as cellular voice/data devices with geo-aware resources that the providers can carry with them into and out of their vehicles. In one embodiment, the communication devices 250 of the candidate providers share a platform (e.g. application level) with the handsets used by the customers. The shared platform enables each party to exchange communications across a shared functionality and user-interface.

Once the respondent 330 starts traveling to the customer's vehicle, estimated arrival information 326 is communicated to the customer 310. The estimated arrival information 326 may be generated automatically, using program instructions that cause the communication device 250 to utilize its geo-aware resources to automatically generate location information of the provider 330 as it progresses en route to the location of customer's vehicle. The estimated arrival information 326 is communicated to the customer 310 using network communications. The estimated arrival information 326 may be communicated directly from the provider 330 to the customer 310, or via the service 320.

According to an embodiment, once the provider 330 arrives at the customer's vehicle, one or both devices can be used to perform cost monitoring functions. The cost monitoring functions enable the calculation of the fee that the customer will have to pay when the vehicle is recharged. In an embodiment, the fee determination is based on the distance or route traveled by the provider 330 and/or the time that the customer's vehicle takes to recharge. The fee determination may also be determined based on a formula or factor that is specific to a particular transport party (e.g. the transport) company or service.

In an embodiment, payment is automatic. The customer 310 may store or associate an online fund account with his device. Likewise, the provider (or alternatively the transport party) has an associated account for receiving funds. Once the customer's vehicle is recharged, service 320 (or the devices as configured) can trigger transfer of funds 342 out of the customer's account. In one embodiment, the funds are transferred from the customer's account to an account of the service 320, which then transfers funds 346 to compensate the provider 330 that provided transport and recharging. The distribution of the funds from the customer 310 may be distributed to the service 320, as well as a transport party that can correspond to either the provider 330, or a business entity that consolidates providers (e.g. fleet operator). The fee transferred 346 from the service 320 to the provider 330 is based on the fee charged to the customer 310, but may include reductions for use of the service 320.

FIG. 4 illustrates a mobile communication device 400 that can be used by either customers or providers, in implementing a system such as described in FIGS. 1-3. Accordingly, mobile communication device 400 may be illustrative of the customer handset (as described in FIG. 3) or the provider communication device 250 (as described in FIGS. 2-3). Accordingly, the mobile communication device 400 may correspond to any one of the following: multi-functional cellular telephony/data device, wireless tablet device, netbook, laptop, GPS computing device, or on-board systems.

Mobile communication device 400 includes GPS component 404, network resources 406, processor 412, and memory resources 414. Other components that may be included with the computing device 400 include, for example, sensors such as an accelerometer. In one implementation, the network resources 406 includes one or more modules for enabling wireless connectivity. The wireless modules may include radios or modems, as well as software or logic for enabling network ports and interfaces through use of the radios. The network resources can include, for example, a cellular data/voice interface to enable the device to receive and send network communications over a cellular transport, including communications to service 320 (see FIG. 3) and/or to the other party. In implementing one or more embodiments, the device may transmit, for example, device identification (e.g. cellular number) and geo-aware communications (as described below). As an alternative or variation, the network resources 406 includes a wireless network interface for connecting to access points (e.g. Wireless Fidelity 802.11(g) or 802.11(n)) or for using other types of wireless mediums (e.g. WiMax).

In an embodiment, device 400 uses the geo-aware resources, shown in form of Global Positioning System (GPS) component 404, as well as network resources 406 to communicate with the service 320 or the providers 330 (see FIG. 3) over cellular or other roaming networks. The device 400 can use the processor(s) 412 and memory resources 414 to execute a program (or corresponding) functionality for either a customer or provider. In some embodiments, the same type of mobile communication device 400 may be used for handsets of customers and providers, but the programming functionality on the handsets may vary for the respective parties.

In one embodiment, the processors 412 execute programming instructions in order to auto-locate and transmit geo-location information to the service 320 or to the device of the other party in the transaction. This functionality enables geo-aware communications to be transmitted from the device. The geo-aware communications may correspond to the customer's request for charging 312 (FIG. 3), in which geographic information 322 is automatically included with the request 312. This functionality also allows for geo-aware communications from the provider 330, which automatically communicates its geographic information of the provider 330 for determining the estimated arrival 326 (FIG. 3) to the customer's vehicle location. In some embodiments, the programming instructions exist in the form of an application that communicates with a service 320 such as described with an embodiment of FIG. 3. The application may execute to utilize various resources of the device, such as the geo-aware resources or accelerometer, to generate requests that automatically include information for recharging requests, such as customer identification and geographic location of the customer's vehicle.

The device 400 also includes geo-presentation resources, to enable mapping or similar presentations using geographic identification information. For example, maps can be stored and/or retrieved on the device to present the position of either party at a given moment. The on-device GPS unit 404 may provide GPS coordinates to the processor 412, which then uses the geo-presentation resources to present ‘real-time’ maps of the provider's position or customer's vehicle position. The processor 412 may also receive GPS coordinates from over a network (via the network interface 406) and use geo-presentation resources and the received GPS coordinates to present the location of the other party at a given instance.

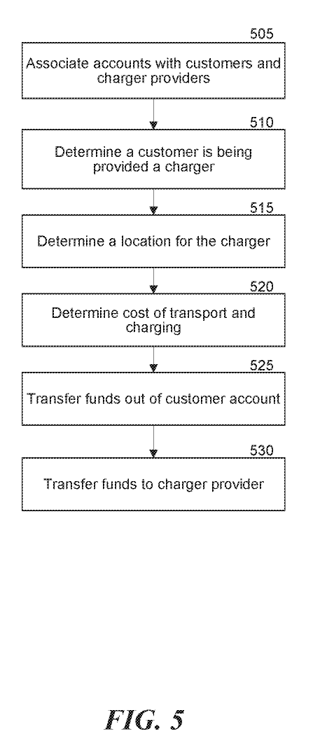

FIG. 5 illustrates a process for programmatically transferring funds from a customer to a relevant provider as a mechanism for compensating the provider for transport and recharging services, according to an embodiment. A method such as described by FIG. 5 may be implemented using components such as described with FIGS. 1-4. Accordingly, reference is made to components of FIGS. 1-4 for purpose of illustrating suitable components for performing a step or sub step being described.

Customers may subscribe to participate in a recharging service such as described with FIG. 3. For customers, their participation may include (i) establishing an account with funds, and (ii) registering and/or enabling a device to utilize the service. For providers, their participation may involve (i) establishing an account to receive funds, and (ii) registering and or enabling a device to utilize the service. In one embodiment, the devices used by the participants correspond to handsets that run applications (“apps”) for participating in the recharging services described. Other types of devices may also be used, such as laptops, tablets, computers, or other GPS enabled devices that have network connectivity. It should also be noted that embodiments contemplate use of more primitive devices, such as those that only enable cellular telephony communications and/or SMS.

In this environment, participants (customers and charger providers) are associated with accounts (505). In the case of the customers, the accounts include funds that can be used for transfer to a provider. For example, the customer may make payments through a specific recharging service account that is managed by the recharging service. The payments may be made, for example, in advance, periodically, or when prompted (such as by the recharging service in response to the customer's vehicle receiving power). The recharging service may have authority to automate transfer of funds from an account of the customer that is not under the control of the service (e.g. checking account, credit card account, PAYPAL account).

As provided with other embodiments, the relevant provider that is to receive compensation for supplying the charger station (directly from the service) can, depending on the implementation and the payment methodology, correspond to (i) the fleet or vehicle operator (e.g. limousine company or entity), and/or (ii) the driver. The provider may establish or associate an account to receive funds from the recharging service and/or account of the customer. Each account may also be associated with profile information of the respective provider, including the identity of the provider.

The recharging service determines when the customer is being provided with a charging station by a provider (510). This determination may be made based on factors that include the customer requesting a charger, and a recharging service selecting a particular provider. In addition to detecting the request for a charger, one or more embodiments detect the location for the charger (515). Similar to the request, this determination may be made automatically, or by way of input from either the customer or the customer's device. Automatic detection of the location for the charger can be made by determining position data (e.g. as determined from GPS or other third party systems, such as Google or Yahoo Maps) for the customer's vehicle.

Once the charging of the customer's vehicle is complete, the payment parameters for the transport and charging are determined (520). The payment parameters can include, but are not limited to, the initial location of the provider, the location of the customer's vehicle, route information (or intermediate positions between the initial location and customer's vehicle location), the duration of the transport, the duration of the charging, and/or the amount of power supplied to the customer's vehicle.

As an addition or alternative to the payment parameters, some embodiments determine the recharging price using other parameters, such as market condition parameters. Market condition parameters may correspond to metrics that estimate or predict availability and demand for transport and charging at a particular time corresponding to when the customer requests a charger. In one implementation, the demand may be based on (i) determining the pool of candidate providers that are in service at the particular time, and (ii) determining the number of charging stations that are engaged by customers at the given time. For example, during peak hours, the number of available charging stations may be at a minimum. Rates for recharging services may be higher at peak than at low demand hours.

Demand can be determined from real-time information maintained by the recharging service. For example, the recharging service may, at a given instance, identify the number of available charging stations and/or the number of providers that are engaged or in service. As an alternative or addition, the demand may be predicted from historical analysis, such as estimations of demand during particular hours of weekdays, weekends, or holidays.

From the payment parameters, the cost for the transport and charging is calculated and transferred from the customer account (525). In one embodiment, the cost is calculated and accessed from the customer account, in response to a determination that the recharging is complete. Alternatively, the transfer of the cost may be performed substantially automatically, such as by way of prompting the customer and/or provider to perform some action or otherwise provide confirmation upon determining that the recharging has been completed.

As mentioned with other embodiments, various methodologies may be used to distribute funds from the customer to the various entities that are involved in providing the transport and charging for the customer's vehicle (530). In one embodiment, the recharging service collects the funds and distributes funds to the pertinent provider periodically, or responsively, after one or more customer vehicles are recharged. The sum total of the fares that are distributed to the provider may represent a portion of the total received. As an alternative, the funds (or portion thereof) collected from the customer can be transferred directly to the provider.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A battery charging system configured for remote power delivery comprising, one or more charging modules positioned on board an electric vehicle and connected to a vehicle power source, wherein the one or more charging modules are configured to: (a) receive power transmitted from an external charging station and charge the vehicle power source, (b) convert DC power supplied by the vehicle power source to AC power that is useable by a motor to propel the vehicle, (c) monitor and control charging of the vehicle power source, and (d) receive and send power to and from a vehicle charging station.

2. A portable charging system configured for remote power delivery to a receiver vehicle comprising, one or more charging modules positioned on board a provider vehicle and connected to a plurality of charging stations configured to be connected to and charge a power source of a receiver vehicle, wherein the one or more charging modules are configured to: (a) convert AC power supplied by an external power source to DC power that is storable by the plurality of charging stations, (b) monitor and control charging of the charging stations, and (c) receive and send power to and from an external power source.
